(19) United States
(12) Patent Application Publication
(10) Pub. No.: US 2010/0031040 A1
(43) Pub. Date: Feb. 4, 2010

(54) Information Communication System

(76) Inventor: Naoto Takano, Chiba (JP)

Correspondence Address: GLENN PATENT GROUP, 3475 EDISON WAY, SUITE L, MENLO PARK, CA, 94025, US

(21) Appl. No.: 12/162,195

(22) PCT Filed: Jan. 25, 2007
(86) PCT No.: PCT/JP2007/051184

§ 371 Date: Jun. 29, 2009

(30) Foreign Application Priority Data
Jan. 30, 2006 (JP) 2006-020207

(51) Int. Cl. H04L 9/32

(52) U.S. Cl. 713/168; 713/150

(57) ABSTRACT

An information communication system comprises: a one-way channel (20) for passing data transmitted from an external network (200) and not passing data from an information communication system (100) to the external network (200); a data scrambling or encrypting apparatus (22) for encrypting the data which has passed through the a one-way channel (20); a first information processing unit (30) for storing the data processed by the encryption apparatus (22) in an external storage device (40) having a plurality of I/O ports (42, 44), at least one of which is a read-dedicated port (44) and at least one of which is a read/write port (42), via the read/write port (42); and a second information processing unit (50) for reading out the data stored in the external storage device (40) via the read-dedicated port (42) and decrypting it.

### FIELD OF THE INVENTION

The present invention relates to an information communication system, unsusceptible for attacks against receiving of dangerous data like a virus program, a spy ware, etc. or against an encryption system.

### BACKGROUND OF THE INVENTION

Conventionally, so-called security software has been used for eliminating computer virus, etc., using signature of files contained in a computer, in order to prevent computer virus or malicious software, etc. from being intruded into a computer (refer to Non-patent Document 1). Providing a firewall is also one of popular methods to prevent computers from malicious software.

An electronic mail itself (hereinafter, refereed to as “e-mail”) on Internet and data attached thereof are transformed to text data by BASE64 algorithm. Those are simply text data immediately after obtained from Internet, so those are inactive for an information processing device such as a computer.

If data were translated into some format whose unit length is less than 8 bit, they do not coincide with executable instruction code of general computers, that is to say, the computer can not execute the instruction code comprising such data. And reversely, if data were translated into some format whose unit length is more than 32 bit, they may coincide with executable instruction code of general computers, that is to say, the computer can execute the instruction code comprising such data. Therefore, in this application, words “active/activate” should be interrelated as “computer executable/making computer executable”, while words “inactive/inactivate” as “computer not-executable/making computer not-executable”.

Therefore, even if a computer virus is included in the received e-mail, a computer which received the e-mail can not have a problem caused by malicious intrusion. In other words, when decoded by the BASE64 algorithm, these become active, so the computer can have a problem caused by intrusion.

On the other hand, data such as web contents are not encoded with the BASE64 algorithm. Therefore, if a computer receives data such as web contents containing a computer virus, the virus will infect the computer.

[Non-patent Document 1] http//www.symantech.com/index.htm

### DISCLOSURE OF THE INVENTION

### Problems to be Solved by the Invention

However, in the conventional technology, the security software cannot deal with the virus, the spy ware, etc. produced after the software is released, so it is impossible to eliminate the virus. Thus, to eliminate such new computer viruses, etc. new versions of the security software correspond to such new viruses must be developed. In addition, generally, development of those viruses may not be accepted, unless it is expected that such new computer virus will cause extensive damages.

A computer generally cannot obtain any information from encrypted data unless they are decrypted. In the same way, firewalls can not detect and interrupt malicious access of the encrypted data. Therefore a data decryption system must be located outside the firewall with respect to Internet.

However, in this configuration, the firewall cannot protect the decryption system, so the decryption apparatus itself must withstand against direct attacks from the Internet and destructive action caused by data itself when decrypted. However, it would be unrealistic that the decryption apparatus can withstand attacks from the Internet, so decrypted data and decryption keys after decryption can be leaked from the decryption system.

Accordingly, the problem to be solved by this invention is to realize an information communication system which can receive malicious data without firewall and security software.

### Means for Solving the Problems

If the order of some data interpretable to a computer is scrambled or encrypted, those data will lose their meaning to the computer. However, those scrambled or encrypted data are unscrambled or decrypted, their meaning will be recovered.

In this application, it should be understood that those words “scrambling/encrypting” etc. appearing in a pair of “scramble” and “encrypt” relate to way which aims to above functions.

Therefore, in this context, words “unscrambled” or “decrypted” should be interrelated as “computer executable” or “making computer executable”, while words “scrambled” or “encrypted” as “computer not-executable” or “making computer not-executable”.

In order to solve the above-mentioned problem, the information communication system of the present invention comprises:

a one-way channel for passing data derived from an external network, while not passing data from the main of the communication information system to said external network;

means for scrambling/encrypting data passed through the one-way channel;

the 1st information processing unit for storing data processed by the means for scrambling/encrypting on a storage device with multi I/O ports, at least one of the multi I/O ports being read-only; and

the 2nd information processing unit for reading the data stored on the storage device through read-only port and unscrambling/decrypting those data.

In other words, the information communication system of the present invention comprises

a one-way channel provided with function at the end which allows to pass only inactivated data or pass data accompanied with scrambling/encrypting process,

an external storage device with multi I/O ports of which at least one is a read-only port,

the 1st information processing unit for receiving inactivated data through the one-way channel and writing said data on the external storage device, and

the 2nd information processing unit, not connected to the external network, for reading inactivated data derived from the external network through the read-only port of the external storage device,

wherein the 2nd information processing unit activates the inactivated data derived from the external network, executes or opens them, or processes them in given ways to obtain results.

The information communication system may be provided with the 3rd information processing device between said one-way channel and said external network.

Furthermore, the information communication system of the present invention may comprises:

a password list contains given passwords obtained beforehand from the sender of the encrypted data;

notifying means to transmit said password and identifier of the data including said password from the 2nd information processing unit to the 1st information processing unit, with the condition that the data decrypted by the 2nd information communication unit include the password; and

means for comparing the password transmitted by the notifying means with the password list, and for deleting the data corresponding to the notified identifier together with said password, if they do not match.

In the present invention, the 3rd information processing unit receives e-mails or web-site contents from the external network, and sends them to the 1st information processing unit through said one-way channel connected.

The one-way channel:

1. transmits no data from the 1st information processing unit to the 3rd information processing unit.
2. transmits BASE64 data from the 3rd information processing unit to the 1st information processing unit

and is able to scramble/encrypt Base64 data.

3. scrambles/encrypts data in other format when they are passed from the 3rd information processing unit to the 1st information processing unit.

Thus, when the 1st information processing unit receives data via the one-way channel derived from the external network, such data are inactivated by the one-way channel, so that they can be treated safely.

To avoid that the 1st information processing unit can know unscramble keys or decryption keys, or the 3rd information processing unit can process “reverse scramble” or “reverse encryption” beforehand which cancels scrambling/encryption by the inactivation means, the scramble/encryption key used by said one-way channel should be concealed within the one-way channel,

The 1st information processing unit receives inactivated data delivered from the external network through the one-way channel, write them into the multi-port external storage device through read/write port, and save them.

If the 1st information processing unit can not know unscramble/decryption keys, and data under BASE64 format are also scrambled or encrypted, the 1st information processing unit can write data into or delete data on the multi-port external storage device without a risk of intrusion caused by wrong operations of user of the information communication system 100 because the inactivated data can not be activated.

An external storage device with multi I/O ports is a storage device such as a hard disk where write/read is possible, with multi I/O ports, at least one of the ports being a read/write port, which is connected to the 1st information processing unit for writing and deleting the inactivated data, and at least one of the rest is a read-only port, which is connected to the 2nd information processing unit for reading the inactivated data derived from the external network.

The 2nd information processing unit has means for activating inactivated data. The 2nd information processing unit reads the inactivated data derived from the external network through the read-only port of the external storage device, and activates and interprets them to act given actions.

If those are malicious data, the 2nd information processing unit will be attacked and it will not work properly. However, since the 2nd information processing unit is isolated from the multi-port external storage device and the one-way channel and the 1st information processing unit, effects caused by the malicious data can not affect the outside of the internal memory in the 2nd information processing unit, even if the malicious data are activated in the 2nd information processing unit, let the processing unit operate, and observe the 2nd information processing unit's behavior.

The reason thereof is that in case of a spy ware, the information of the 2nd information processing unit can be cached by the spy ware, but there is no means for transmitting them to the outside, and in case of virus which acts stepping-stone attack, there is no means for accessing a PC on the external network.

Furthermore, re-booting the 2nd information processing unit erases all hacker's trails even after having executed the malicious codes. Thus, the 2nd information processing unit is safe, even if executing the malicious code on it and watching the behavior thereof.

### DETAILED DESCRIPTION OF THE INVENTION

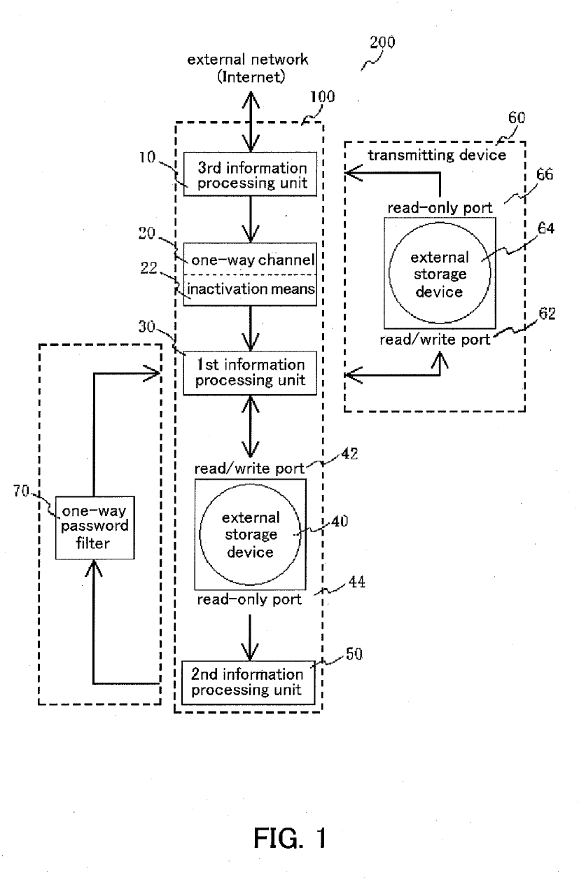

The implementation of the present invention will be explained hereinafter referring to FIG. 1.

FIG. 1 is a block diagram showing the configuration of the information communication system 100 in implementation of the present invention.

The 3rd information processing unit 10 shown in FIG. 1 is connected to both entrance of the one-way channel 20 and the external network 200 via analog phone, ISDN phone, DSL, CATV, optical fiber, ether-NET, 10BASE-T, 100BASE-T, infrared, wireless, etc. lines. The 3rd information processing unit 10 mainly receives data from other information communication systems (not shown in FIG. 1) connected to the external network 200. However, it is also possible to send data output from an information transmitting unit 60 to other information communication devices through the external network 200.

The function of the one-way channel 20 is to receive data from the external network 200 through the 3rd information processing unit 10 and to transmit the data to the 1st information processing unit 30, while to prevent the data of the 1st information processing unit 10 from being output to the 3rd information processing unit.

In other words, the one-way channel 20 passes data from the external network 200 to the 1st information processing unit 30, but prevents data of the 1st information processing unit 30 from being passed to the external network 200. As the one-way channel 20, tapping devices used in LAN, or printer buffers(including USB type) without bi-directional communication function, etc. may be available.

It is also possible to arrange that the one-way channel 20 passes only given type of data such as ones consisting of only characters or ones under BASE64 format.

The one-way channel 20 should keep functions of one-way nature, restriction of transmittable data type and of scramble or encryption. Therefore, to prevent hacking, it will be better that said functions are realized by the structure of electric circuit itself, or by firmware which requires particular physical operations for its modification.

Since the information communication system 100 in the present implementation is provided with the one-way channel 20, the system information of the 1st information processing unit 30 or the information of the Intranet connectable to the 1st information processing unit can be prevented from leakage to the external network 200.

Data scrambling or encrypting apparatus 22 is attached on the output end of the one-way channel 20. The scrambling or encrypting apparatus 22, may be attached to or included in the one-way channel 20. Any reversible method for scrambling or encrypting is employed as the scrambling or encrypting method. The scrambling or encrypting apparatus 22 randomly modifies data derived from the external network 200 to be inactive.

Here, the keys used in the scrambling or encrypting apparatus 22, are not leaked to the 3rd information processing unit 10 due to the one-way nature of the channel 20. The said keys are kept within the scrambling or encrypting apparatus 22 such that neither the 3rd information processing unit 10 nor the 1st information processing unit 30 can know them. This is because it is important for the security that the 1st information processing unit 30 must not unscramble/decrypt data.

However, if the data type is BASE64 which is inactive, then scrambling/encrypting process may be omitted.

The 1st information processing unit 30 receives the data derived from the external network 200 through the output of one-way channel 20 and writes them into the external storage device 40 through the read/write port 42. Practically, the data derived from the external network 200 cannot be malicious data for attacking the 1st information processing unit 30. Therefore, popular computers are available as the 1st information processing unit 30.

The 1st information processing unit 30 can not be attacked by computer viruses, etc. and can not activate the data derived from external network 200, so that the external storage device 40 can not be attacked by computer viruses even if computer viruses are included in the data to be saved.

The data under BASE64 format where 1 word consists of less than 6 bits cannot construct the instruction set of common CPU. Therefore, the data under BASE64 format cannot compose codes executable in the 1st information processing unit 30. Then if the one-way channel 20 passes only data under BASE64 format, scrambling or encryption/unscrambling or decryption processes may be omitted.

An external storage device 40 is connected to the 1st information processing unit 30. The external storage device 40 is an external storage device like a hard disk which data can be written on or read from. However, the external storage device 40 in this implementation obligatory has more than or equal to two I/O ports. These I/O ports work independently. At least one of those I/O ports is a read/write port 42 and at least one of the rest is a read-only port 44.

The read/write port 42 is connected to the 1st information processing unit 30. The inactivated data derived from the external network 200 are written to or deleted from the external storage device 40.

The read-only port 44 of the external storage device is connected to the 2nd information processing unit 50. The 2nd information processing unit 50 can read the inactivated data derived from the external network 200 written in the external storage device 40.

The read-only restraint of the port should be guaranteed such that any hacker can not change it.

In this respect, a hard disk drive having “2 port controller where the read-only restraint is realized by the structure of electric circuit itself, or by firmware which requires particular physical operations for its modification”, or a hard disk drive with mechanically independent multi heads, are suitable for the above-mentioned purpose. The hard disk may be replaced by flash memories, DVD-RAM, silicone disk, hologram memory, etc.

It should be noted that the information communication system 100 shown in FIG. 1 has no external storage device on which the 2nd information processing unit 50 can write data.

Furthermore, the transmitting device 60 can be selectively connected to the 1st information processing unit 30. The transmitting device 60 is provided with the external storage device 66 which has the same hardware structure as the external storage device 40. As shown in FIG. 1, the read/write port 62 of the transmitting device 60 is connected to the 1st information processing unit 30, and the read-only port 66 of the transmitting device 60 is connected to the 3rd information processing unit 10. If the transmitting device 60 is added, the 1st information processing unit 30 can read information stored in the external storage device 40 and send them to the external network 200 through the transmitting device 60 and the 3rd information processing unit 10.

The 2nd information processing unit 50 is connected to the external storage device 40 through the read-only port 44. The 2nd information processing unit 50 has means for activating the inactivated data. The 2nd information processing unit 50 can read inactivated data derived from the external network 200 through the read-only port 44 of the external storage device 40. However, the 2nd information processing unit 50 cannot modify or delete the data on the external storage device 40. Therefore, for example, the 2nd information processing unit 50 cannot falsify or activate the data on the external storage device 40 and make the 1st information processing unit 30 to read them and to cause malicious actions. The 2nd information processing unit 50 is not directly connected to the external network 200.

As mentioned above, the 2nd information processing unit 50 works without writable external storage device. The 2nd information processing unit 50 is connected with the read-only port 44 of the external storage device 40 and/or read-only devices like CD-ROM. The 2nd information processing unit 50 is booted up by said read-only devices, etc. and the software to be used is also read from said read-only devices.

If the data ware converted under BASE64 format, the 2nd information processing unit 50 un-converts them. Furthermore, if the read data were scrambled or encrypted by the scramble/encryption means 22, they are unscrambled or decrypted by the 2nd information processing unit 50.

In this stage, if those data contain computer viruses, the software run on the 2nd information processing unit 50 may be falsified and the 2nd information processing unit 50 may be hacked. In other cases where the system has not been hacked yet, the information communication system 100's user input an instruction of “to open files” for the 2nd information processing unit 50, then the 2nd information processing unit 50 being hacked may be caused.

However, the 2nd information processing unit 50 is connected to the external storage device 40 through the read-only port 44. The 2nd information processing unit 50 is isolated from the 1st information processing unit 30 and the one-way channel 20. Therefore, even if the 2nd information processing unit 50 cannot work properly, malicious data cannot go get-out to the external storage device 40, etc. Eventually, even if the 2nd information processing unit 50 reads malicious data, the effect caused by the malicious data might cause only breakage of its inside memory of the 2nd information processing unit 50 at the maximum, so that it will not affect the external storage device 40.

When it is found that the data derived from the external network 200 are malicious, this shall be notified to the 1st information processing unit 30 through the one-way password filter 70 (which will be described later), which leads to delete relevant malicious data on the external storage device 40. After that, by re-booting procedure for the operating system of the 2nd information processing unit 50, the system will be recovered from the hacked situation and falsified software in the 2nd information processing unit 50 will be also recovered.

To be more careful, it should be preferably considered that the data derived from the external network 200 may be so-called “time bomb” type virus. In this case, even if it is confirmed that those data are safe, it will be better to use always the 2nd information processing unit 50 for repeated browsing.

If the data derived from the external network 200 is a spy ware, the 2nd information processing unit 50 will be infected. However, the 2nd information processing unit 50 can not access the 3rd information processing unit 10, so no data stored on the external storage device 40 can be exported to the external network 200. Furthermore, the 2nd information processing unit 50 is not provided with any writable external storage device on which spy wares can be written, so that such spy wares are erased by power-off and/or re-boot of the 2nd information processing unit 50.

If the data derived from the external network 200 is a virus, it will attack the 2nd information processing unit 50. However, the 2nd information processing unit 50 is not connected to the external network 200, so it will not affect any system outside the information communication system 100.

Thus, for example, the following typical effects may be expected. When the data derived from the external network 200 is a cryptograph, usually the 2nd information processing unit 50 activates it and then decrypts it. If said cryptograph is malicious data, the 2nd information processing unit 50 might not be able to decrypt it. Furthermore, it might attack the decryption program, e.g. to obtain decryption keys. However, even if a hacker succeeds to obtain decryption keys, the hacker cannot bring them out from the 2nd information processing unit 50.

Thus, according to the present invention, if the user of the information communication system 100 tries to browse any data derived from the external network 200, there is no risk of exportation of malicious effect to the inside/outside of this information communication system 100. In other words, decryption of cryptographs can be processed safely in the 2nd information processing unit 50.

Under the condition where the data sender and the data receiver decided beforehand passwords such that collision of passwords is negligible, if the data sender sends the encrypted data including the “password” to the information communication system 100, the user of the information communication system 100 who receives the data can authenticate the sender by confirming whether two “passwords” coincide or not.

Users can confirm whether the passwords decrypted by the 2nd information processing unit 50 are correct or not by displaying them on a display (not shown), by printing them or by making a speaker to talk them.

What the password is correct means that the data sender is authenticated to be correct one and the path between the sender and the receiver is secure.

Regularly, the 2nd information processing unit 50 is not provided with any output port, but there may be provided with means for transmitting the password and file ID (such as file name) of file including the password to the 1st information processing unit 30. The 2nd information processing unit without writable device or writable port simply realizes absolute security. Therefore this condition is recommended but not obligatory. In this case, if there is further provided with means by which if the list of decided passwords and the list of sent passwords are compared, and they do not match, then the file of the file ID is deleted from the external storage device 40.

That is to say, if the “passwords” do not match, the relevant data should be deleted from the external storage device 40. If the two passwords match, it is safe to unscramble/decrypt relevant data. Furthermore, if the 1st information processing unit 30 obtains unscramble or decryption keys in some way, the 1st information processing unit 30 can use the data.

A one-way printer buffer which passes e.g. only character code can be used as the one-way password filter 70. The one-way password filter 70 passes only numerical codes, provided that the “pass word” and identifier of the file including said password are composed of only numbers.

The “password” filter's function of one-way restraint and of restraint for passing only character code, etc. should be guaranteed such that a hacker can not control the restraint. Thus it will be better that said restraints are realized by the structure of electric circuit itself, or by firmware which requires particular physical operations for its modification.

If the 1st information processing unit 30 has means for re-booting the operating system of the 2nd information processing device 50 when signals from the one-way password filter 70 notifies malicious encrypted data being processed, successive automatic decryption for cryptographs becomes possible. It is because the software which successively activate and decrypt data derived from the external network 200 can be prevented from working while being hacked.

The present invention may be principally applied to communication industry.

FIG. 1 is a block diagram showing a schematic configuration of the information communication system 100 and peripheral devices thereof in an embodiment of the present invention.

### BRIEF DESCRIPTION OF THE DRAWINGS

### Explanation of Signs

10: 3rd information processing unit
20: one-way channel
22: inactivation means
30: 1st information processing unit
40: external storage device
42: read/write port
44: read-only port
50: 2nd information processing unit
60: transmitting device
70: one-way password filter

1. An information communication system comprising:
a one-way channel for passing data derived from an external network, but not passing data from the main of the information communication system to said external network;
means for scrambling/encrypting data passed through the one-way channel;
a 1st information processing unit for storing the scrambled/encrypted data through a read/write port on a storage device with multi I/O ports, at least one of the multi I/O ports being the read-only port; and
a 2nd information processing unit for reading those data stored on the storage device through the read-only port and for unscrambling/decrypting those data.

2. An information communication system according to the claim 1, further comprising
the 3rd information processing unit connected between the one-way channel and the external network.

3. An information communication system according to claim 1, further comprising:
a password list containing given passwords obtained beforehand from the sender of the encrypted data;
notifying means for notifying said password and identifier of the data to the 1st information processing unit, under the condition that the data include the password decrypted by the 2nd information communication unit; and
means for comparing the password notified by the notifying means with the password list, and deleting the data corresponding to the identifier notified with said password, if they do not match.

4. An information communication system according to claim 2, further comprising:
a password list containing given passwords obtained beforehand from the sender of the encrypted data;
notifying means for notifying said password and identifier of the data to the 1st information processing unit, under the condition that the data include the password decrypted by the 2nd information communication unit; and
means for comparing the password notified by the notifying means with the password list, and deleting the data corresponding to the identifier notified with said password, if they do not match.
